(19) United States
(12) Patent Application Publication
(10) Pub. No.: US 2015/0287349 A1
(43) Pub. Date: Oct. 8, 2015

(54) METHOD OF DEPICTING AN IMAGE

(71) Applicants: Michael John MERIFIELD, 7975 Fish Hoek (ZA); Michel BROWN, 7405 Pinelands (ZA)

(72) Inventors: Merifield John Michael, 7975 Fish Hoek (ZA); Brown John Walter Michael, 7405 Pinelands (ZA)

(21) Appl. No.: 14/439,499

(22) PCT Filed: Oct. 29, 2013
(86) PCT No.: PCT/IB2013/059739

§ 371 Date: Apr. 29, 2015

(30) Foreign Application Priority Data
Oct. 31, 2012 (GB) 1219539.2

(51) Int. Cl. G09F 19/14; G06T 11/60; D06C 11/00

(52) U.S. Cl. CPC G09F 19/14; D06C 11/00; G06T 11/60

(57) ABSTRACT

A visual advertisement is disclosed which is carried by a substrate. The advertisement comprises a first inverse perspective transformation image and a contiguous second inverse perspective transformation image. The images are inverted with respect to one another. The first image, when the images are viewed in one direction, is the predominant image and the second image is a subsidiary image. When the images are viewed in the opposite direction the second image is the predominant image and the first image is the subsidiary image.

### FIELD OF THE INVENTION

The present invention relates to a method of depicting an image, and in particular to a method of depicting an image intended for viewing from a predetermined viewing position relative to a predetermined image position. More particularly, but not exclusively, the invention relates to the depiction of images of an advertising or promotional nature at sporting events, which may be viewed through an image capturing and/or transmitting device, such as a television camera.

### BACKGROUND TO THE INVENTION

In PCT application No. PCT/GB92/01538 published as WO93/04559 there is disclosed a method of depicting an image which includes applying an inverse perspective transformation (IPT as hereinafter defined) of the image to a surface, and imaging the surface, with the transformed image depicted thereon, by means of a moving picture camera whose line of sight corresponds to the line of sight used in transforming the image to its inverse perspective form. The specification describes how to achieve the desired effect, including describing how inverse perspective transformation is achieved.

The problem that the invention of the PCT specification sought to overcome was that a sponsor's logo, when applied to a surface at a televised sporting event using the then conventional methodology, resulted in a distorted image that was difficult to read on television. The reason for this was the result of the compression and narrowing of the visual image caused by the phenomenon of perspective.

Carrying out an inverse perspective transformation (IPT) of an image and then applying this IPT image to a playing surface at a televised sporting event had the result that the IPT image on television appeared ‘correct’ and “stood up” at an angle to the line of vision.

An IPT image can be generally described as a complex elongation of the image along the line of sight where the complex elongation is a result of applying a combination of desired visual image size as well as progressive stretch and key-stoning. The precise determination of this combination is dictated by the combined relationship of height and distance of the camera viewpoint from the intended IPT image position on the playing surface.

One of the first televised sports to embrace the application of this IPT technology was the sport of cricket which is played on a pitch in the middle of the playing field. Cricket is one of the very few sports that is filmed from diametrically opposed ends of the field of play with camera positions at each pitch-end. An obvious drawback, of course, is that applying on-field signage intended to be viewed from one camera position will appear upside-down when viewed from the other camera position. In the following description the expression “near side logo” refers to the one between the camera and the pitch and the expression “far side logo” is the logo on the side of the pitch remote from the camera. The term “pitch-end” is used to designate those logos which are in line with the pitch as opposed to those at the positions on the field designated square leg and gully.

Prior to the application of IPT images, sponsors had out of necessity placed their pitch-end logos on the near side and as close as possible to the cameras as this minimised the compromising effect of perspective on a conventional “true” image. It was inevitable that IPT images would initially be placed in similar positions as this was what sponsors' were used to. While it was generally accepted that the far side logo at the opposite end of the ground would appear upside down, the upside down logo was now slightly more obvious to the viewer owing to the elongation or stretch that the IPT caused. As viewers were already conscious of the fact that the far side logo would be upside down, this was not cause for concern.

However, it was not long before it was realised that the far side logo, that is, the one behind the wicket keeper, i.e. the upside down logo, got more television exposure than logos positioned on the near side. Also, as the game of cricket saw the faster formats of the game evolve, i.e. limited overs, ODI's and T20's etc, the upside down positioning of the far side logos became even more evident in the filming of these hyper action events. Sponsors then requested that their logos be placed on the far side so that it appeared to the viewer to be the right way up behind the keeper in the close-up shots of the batsmen at the crease. From the viewpoint of the closest camera, the logos were then upside down.

Far side positioning of the logo increases the viewing distance from the camera necessitating an increase in the elongation of the IPT image. This then impacts negatively on the near side logo as it as the image to be viewed appears on-screen upside down and with much greater elongation than before.

In spite of this drawback, the choice of pitch-end far side logos over pitch-end near side logos remains very popular with sponsors. However, the impact of the pitch-end near side logo appearing on-screen up-side down and distorted is distracting. To see a sponsor's logo upside down is a distraction and is also a waste of potential advertising space.

The object of the present invention is to overcome the image presentation difficulties discussed above.

### BRIEF DESCRIPTION OF THE INVENTION

According to a first aspect of the present invention there is provided a visual advertisement which is carried by a substrate, the advertisement comprising a first inverse perspective transformation image and a contiguous second inverse perspective transformation image, the images being inverted with respect to one another and the first image, when the images are viewed in one direction, being the predominant image, and the second image being a subsidiary image and the second image being the predominant image when the images are viewed in the opposite direction and the first image being the subsidiary image.

The images are superimposed on one another or can be end-to-end in the direction of the line along which the images are viewed.

According to a second aspect of the present invention there is provided a mat comprising upstanding pile elements each of which has a first surface and an opposed second surface whereby said first surfaces are the only visible surfaces when the mat is viewed in one direction and the second surfaces are the only visible surfaces when the mat is viewed in the opposite direction, each of said first surfaces having part of a first image applied thereto, such parts together constituting the first image, and each of said second surfaces having part of a second image applied thereto, such parts together constituting the second image.

According to a third aspect of the present invention there is provided a method of producing images which comprises providing a mat having a backing and a pile upstanding from the backing and constituted by strands which have discrete opposed surfaces, manipulating the strands so that they lie over in one direction to expose one surface of each strand, applying a first image to said one surfaces of the strands, manipulating the strands so that they lie over in the opposite direction to expose the other surfaces of the strands, applying a second image to said other surfaces, and manipulating the strands back to their position normal to the backing.

According to a fourth aspect of the present invention there is provided a method of producing a mat which carries two images one of which is visible as an accurate image when the mat is viewed in one direction and the other of which is visible as an accurate image when the mat is viewed in the other direction, which method comprises printing images in alternating strips, and inverted with respect to one another, onto a sheet, securing an edge zone of the sheet to a backing layer, folding the sheet adjacent to said edge zone to provide a double thickness rib one external face of which carries part of one image and the other external face of which carries part of the other image, attaching the rib, on the opposite side to said zone, to the backing layer and repeating the attaching and folding sequence to provide a multitude of parallel ribs.

The sheet can, in a modification of the method, be replaced by a plurality of ribbons.

According to a fifth aspect of the present invention there is provided a method of producing two images one of which is visible as the predominant image when viewed in one direction and the other of which is visible as the predominant image when viewed in the opposite direction, the method comprising applying inverted first and second images immediately adjacent one another along the viewing line.

In a modification of this method the images are superimposed on one another.

One image is preferably bigger than the other and the images can be inverse perspective transformation images.

According to a sixth aspect of the present invention there is provided, in combination, a mat comprising a plurality of light emitting diodes and a computer for controlling the diodes to illuminate those required to produce an image.

The diodes can be controlled so as to be illuminated to produce two inverse perspective transformation images one of which predominates when viewed from one direction and the other of which predominates when viewed from the opposite direction.

In one form of the mat the images are end-to-end in the direction of viewing and in another form the images are superimposed on one another.

### BRIEF DESCRIPTION OF THE DRAWINGS

For a better understanding of the present invention, and to show how the same may be carried into effect, reference will now be made, by way of example, to the accompanying drawings in which;

FIG. 1 is a plan view of a strip of a sheet from which a mat can be manufactured;

FIG. 2 is a side elevation diagrammatically illustrating a mat manufactured using the sheet of FIG. 1;

FIG. 3 is a diagrammatic side elevation of a further form of mat,

FIG. 4 is a side elevation of the mat after being rolled in one direction;

FIG. 5 is a top plan view of the mat of FIG. 4;

FIGS. 6 and 7 are views similar to FIGS. 4 and 5 and show the mat when rolled in the opposite direction;

FIGS. 8 and 9 show the mat when viewed in the directions of arrows V1 and V2 respectively in FIG. 3;

FIGS. 10 and 11 illustrate mats which respectively carry generally rectangular images and generally circular images;

FIGS. 12 and 13 illustrate how rectangular, superimposed images will appear when viewed by television cameras on the far side and near side of the pitch;

FIG. 14 illustrates IPT images which are adjacent to one another in the direction of the length of the pitch;

FIGS. 15 and 16 illustrates the images of FIG. 14 when viewed respectively from the near side and the far side;

FIG. 17 illustrates two superimposed IPT Images and indicates viewing directions V1 and V2; and

FIGS. 18 and 19 illustrates the images of FIG. 17 as viewed by the cameras along the lines V1 and V2.

### DETAILED DESCRIPTION OF THE DRAWINGS

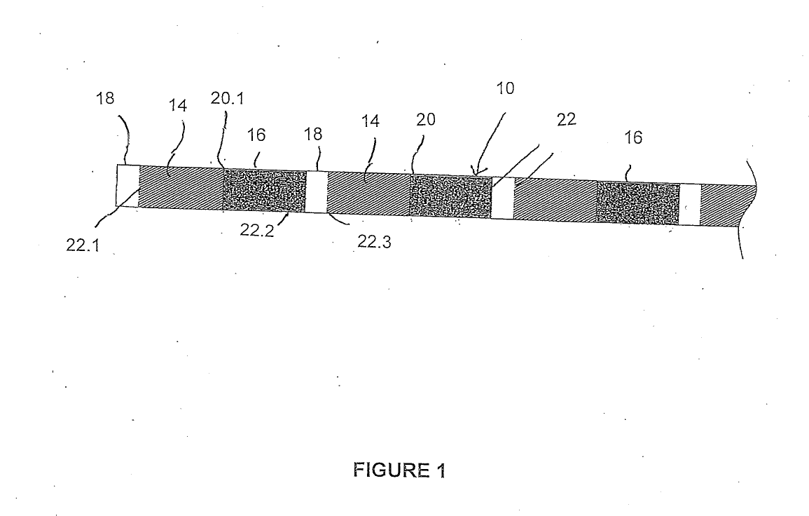

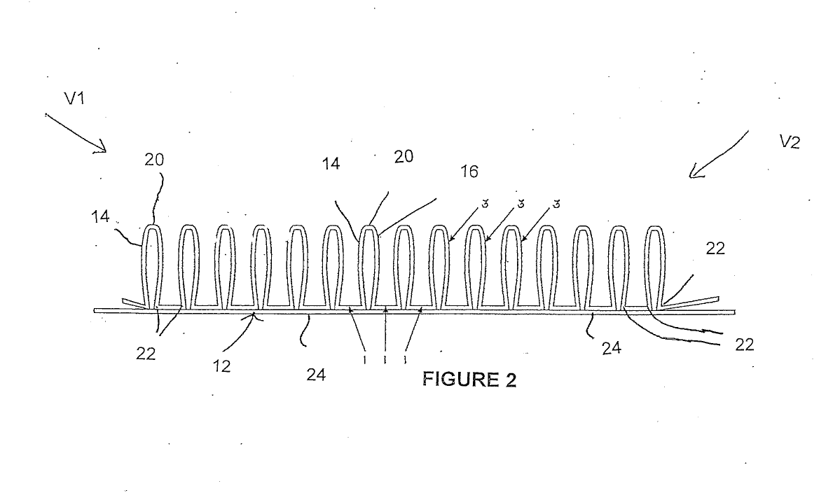

Referring firstly to FIGS. 1 and 2, reference number 10 designated a strip of a sheet from which the mat 12 FIG. 2 can be manufactured.

The width and length dimensions of the sheet are chosen in dependence on the size of the image required and hence on the necessary size of the mat. The transverse strips 14 of the sheet in FIG. 1 which are cross hatched are printed so as to form part of one image and the transverse strips 16 of the sheet which are black are printed so as to form part of another image. The plain white strips of the sheet, which are designated 18, are not printed and retain the colour of the material of the sheet.

The transverse lines 20 indicate where the sheet is formed with a hairpin bend and the transverse lines 22 indicated where the sheet is folded through a right angle and stitched to secure it to a backing layer 24 (FIG. 2).

The mat is manufactured by initially stitching the sheet 10 and backing layer together along the left hand line designated 22.1. The sheet 10 is then folded into a hairpin bend along the left hand line designated 20.1 and then stitched to the backing layer again along the lines 22.2 and 22.3. This continues until the entire length of sheet has been stitched to the backing layer 24. The strips 14 or the strips 16 will be seen when viewed via television cameras positioned to televise the mat along the lines V1 and V2 in FIG. 2.

A sheet 10 can be handled most readily during manufacture but it is also possible for the sheet to be replaced by a plurality of ribbons. FIG. 1 can consequently be considered as showing a strip forming part of a sheet or as one of a multitude of ribbons used to form the mat.

The term inverse perspective transformation (IPT) as used herein means a transformation of the original image which compensates for one or more of the effects of natural perspective, thereby having the effect of making a two dimensional original image appear three dimensional as a viewed image, and including at least one of:

i stretching the image along the line of sight;
ii Increasing the spacing of image features along the line of sight (i.e. equal distances in the original image become increasingly larger in the transformed image as they move away from the predetermined viewing position along the line of sight); and
iii diverging lines that appear parallel in the original image, as they extend away from the predetermined viewing position along the line of sight;
or any combination of the above.

Whilst is it preferred that the images be painted in accordance with the procedure of ii above, it is also possible for the images to be produced by simple stretching of the image (as per (i) above) in the direction of the line of sight from the camera position to the image. Such images are accurate in the sense used in this specification but, in fact, do show some distortion due to the natural effects of perspective, which does not occur when features (i) and (iii) are both used.

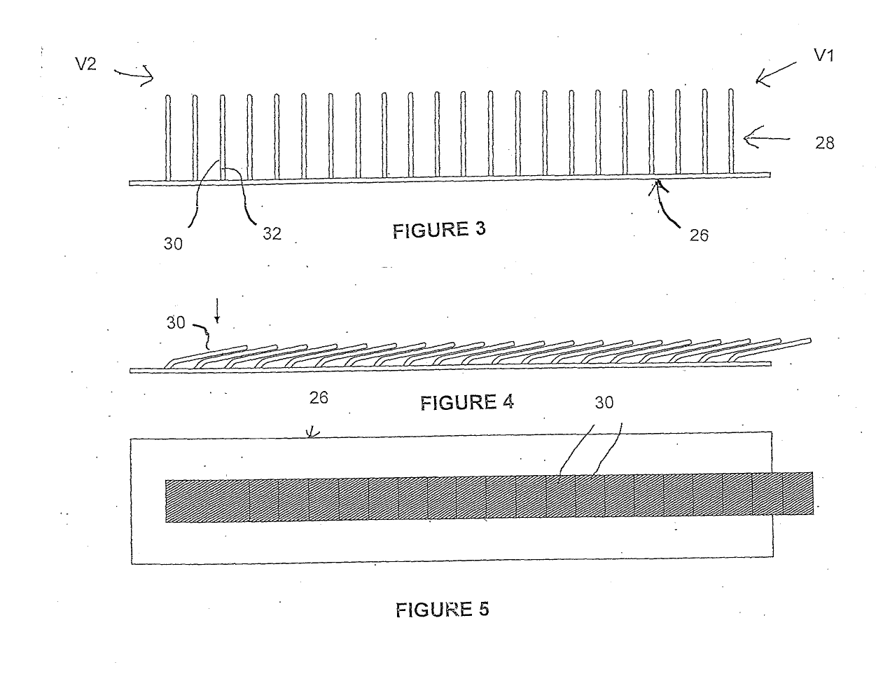

Turning now to FIGS. 3 to 9, the mat illustrated comprises a base layer 26 and a pile 28 which consists of upstanding strands which are of a configuration that presents two distinct faces 30 and 32.

To achieve the two requisite IPT images the mat is combed and/or rolled so that the strands lay over and only the faces 30 are exposed as shown in FIGS. 4 and 5. The surfaces 30 are then printed with a first IPT image as shown by the hatching of FIG. 5.

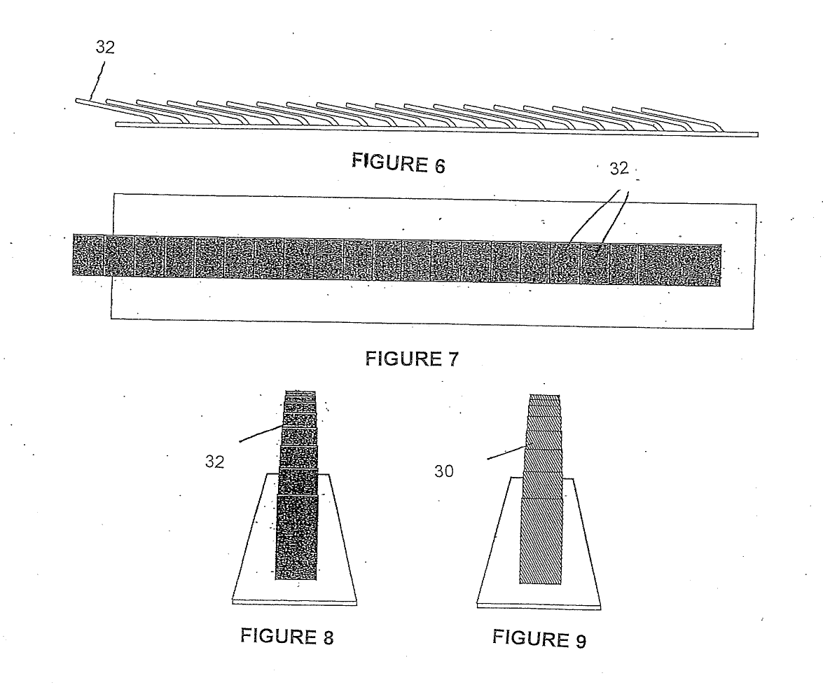

The mat is then combed and rolled in the opposite direction (FIG. 6) so that the strands lay over in the opposite direction and only the faces 32 are exposed. The second IPT image is then printed onto the faces 32 as shown by the dark colouring in FIG. 7. The strands are then combed back to the upright position shown is FIG. 3.

When viewed by the opposed cameras along lines V1 and V2 in FIG. 3, one camera “sees” the faces 30 and the other camera “sees” the faces 32 as shown in FIGS. 8 and 9.

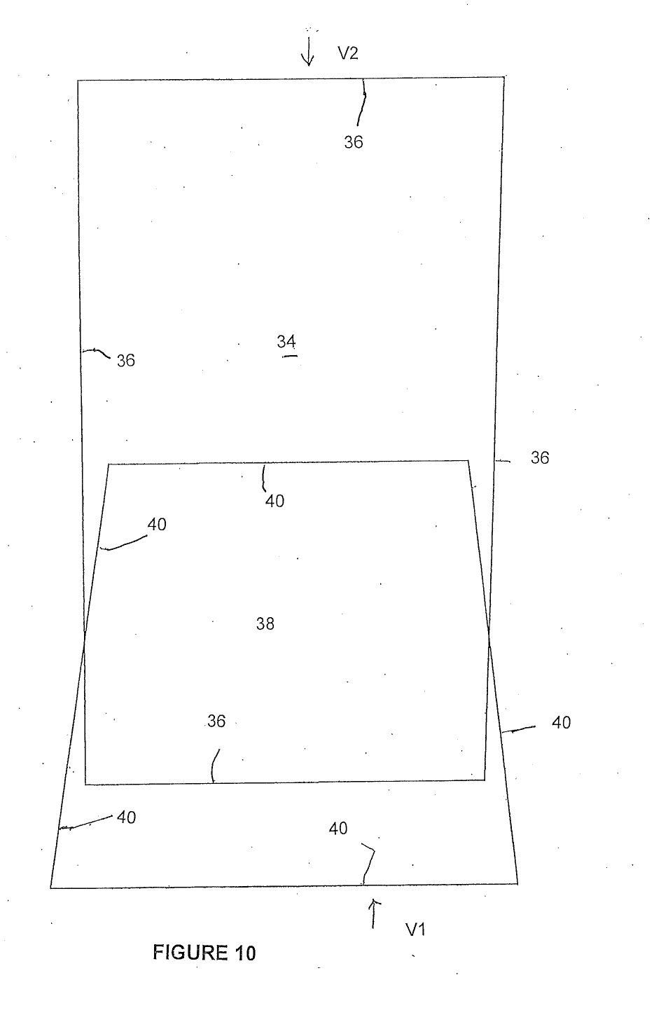

The mat shown in FIG. 10 carries one generally rectangular image 34 bounded by the lines 36 and an image 38 of trapezium shape bounded by the lines 40. The images are positioned on the playing field so that the near side camera views the mat along the line V2 and the far side camera views the mat along line V1. The rectangular image 34 is the image that is intended to be viewed along V1 and appears to “stand up” from the playing surface. The image 38 forms a shadow of the image 34. The image 38 is intended to be viewed by the near side camera and the image 34 appears to the near side camera as a shadow of the image 38.

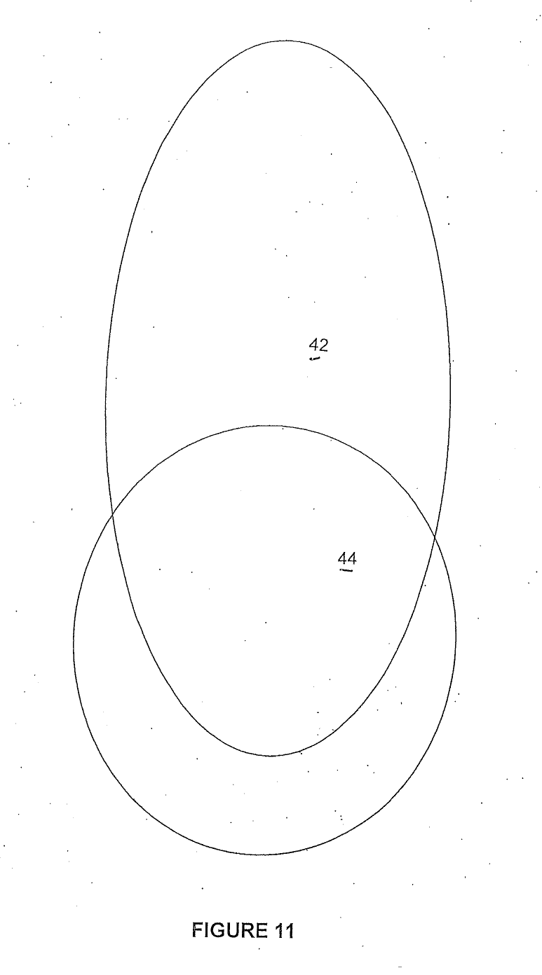

FIG. 11 shows how two generally circular overlapping images 42, 44 are positioned on a mat.

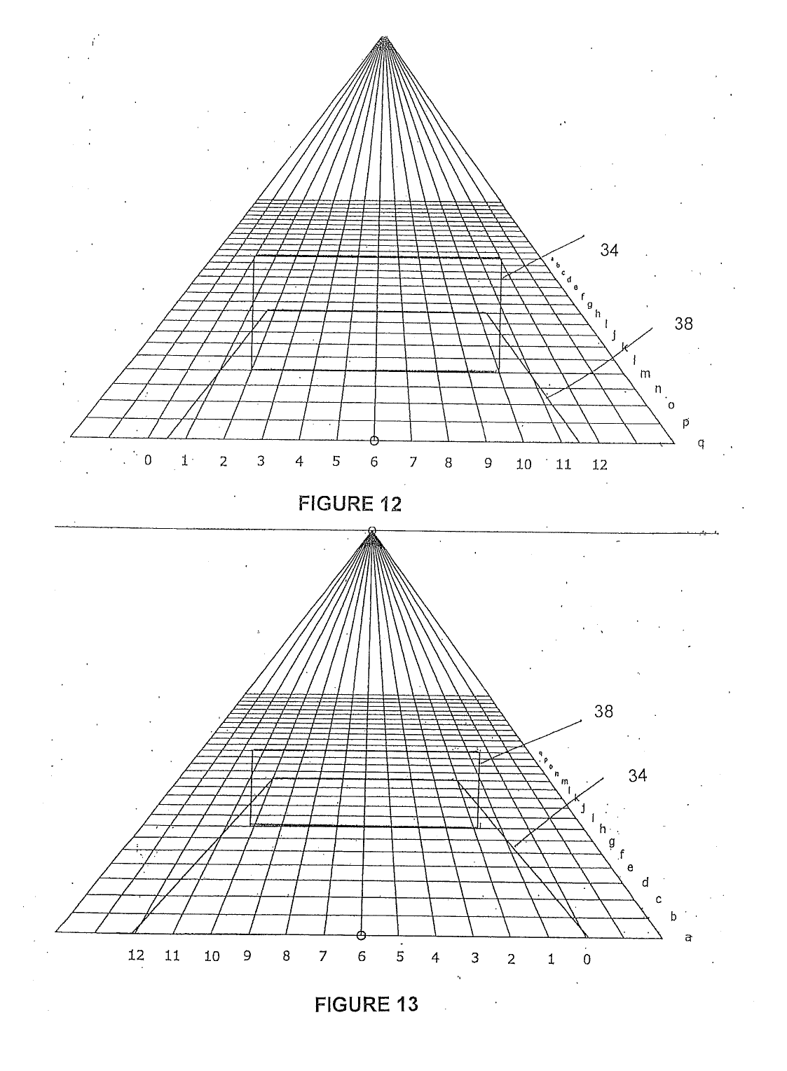

When the mat of FIG. 10 is viewed by the far side camera as shown in FIG. 12 in direction V1, the image 34 is the image which is intended to be viewed. It “stands up” from the playing field. The image that is not primarily intended to be viewed by the far side camera in direction V1 is designated 38 and appears to be a shadow of the image 34.

When viewed from the near side camera (FIG. 13) from direction V2 it is the image 38 which stands up and the image 34 which forms a shadow.

It will be understood that if the IPT images are to be painted directly onto grass, it is not possible satisfactorily to be able to “comb” the grass and achieve the effect which can be obtained using a mat. However, the images can be painted adjacent one another to obtain, when the images are viewed in either camera direction, a distinct image and what appears to be a shadow of the distinct image.

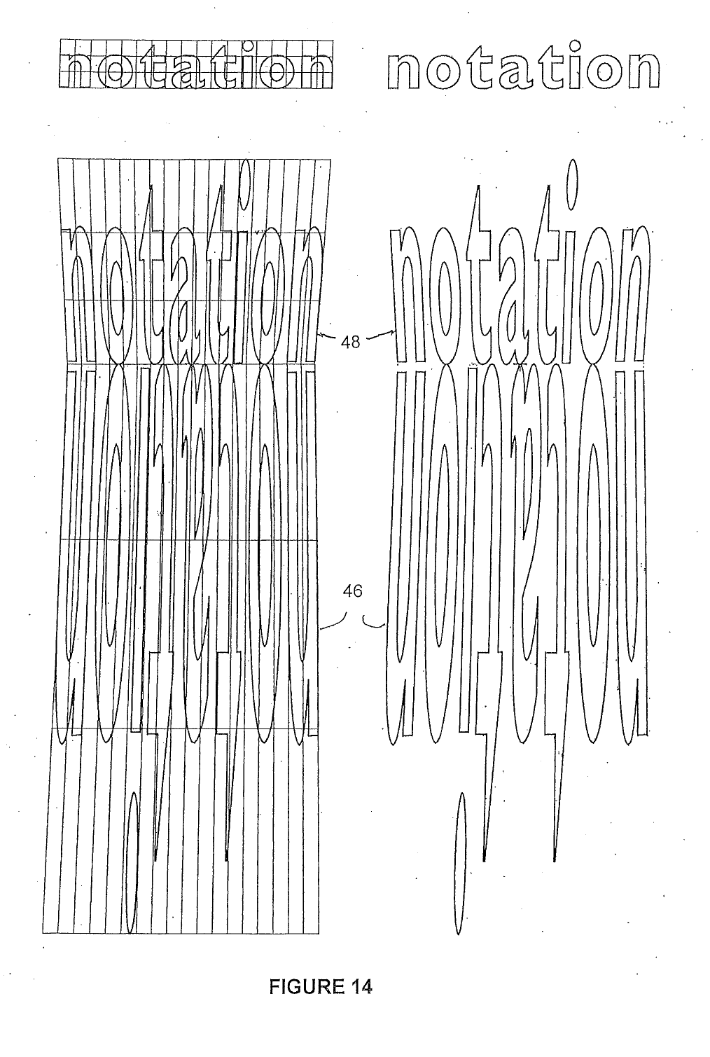

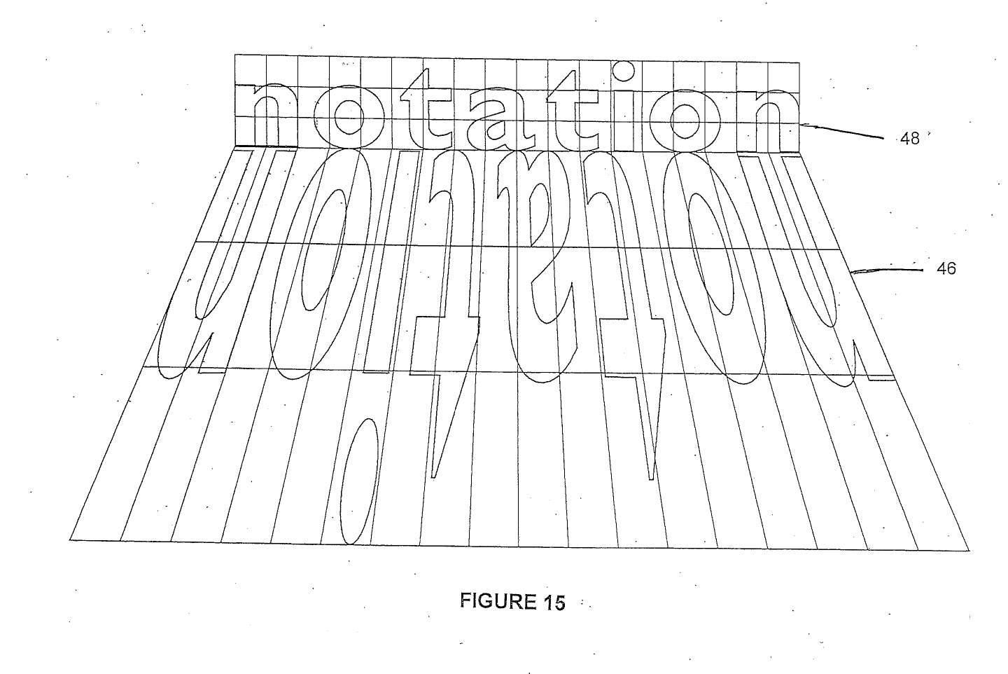

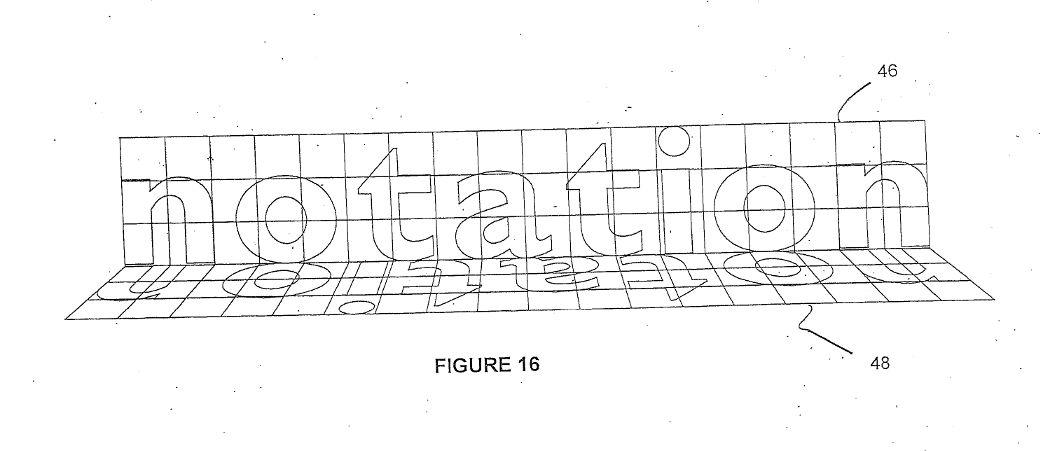

FIG. 14 illustrates the painting of two IPT images of the word “Notation” designated 46 and 48 and adjacent one another in the direction of the line of viewing. The image 46 is intended to be viewed by the far side camera and it “stands up” (see FIG. 16) when viewed by that camera. The image 48 appears to lie flat and to be a shadow of the image 46. When viewed from the near side camera it is the image 48 that “stands up” and the image 46 that appears to form a shadow of the image as shown in FIG. 15. On the left hand side of FIG. 14 the grid used to obtain an IPT image is shown.

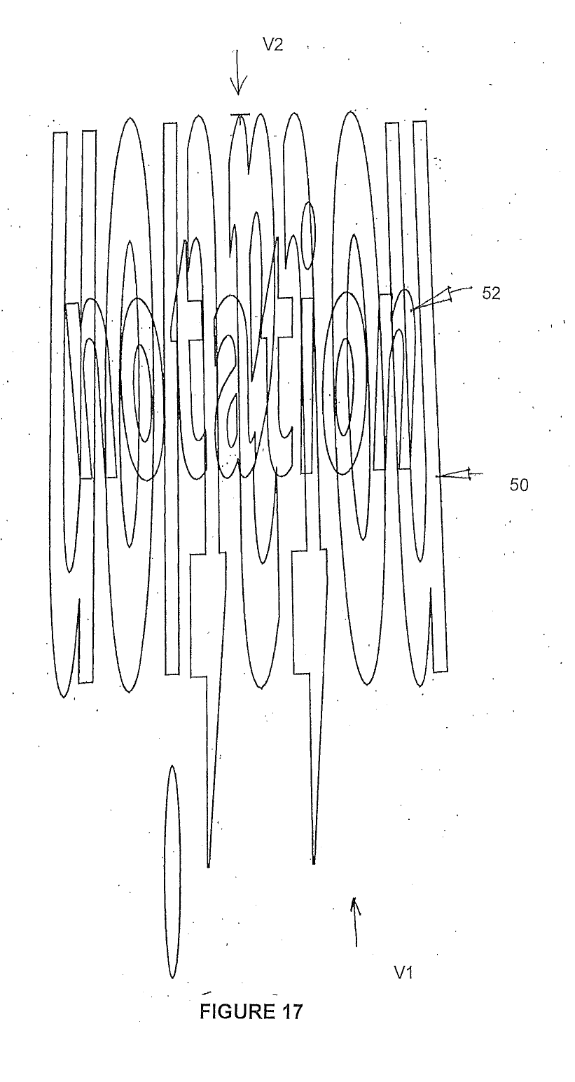

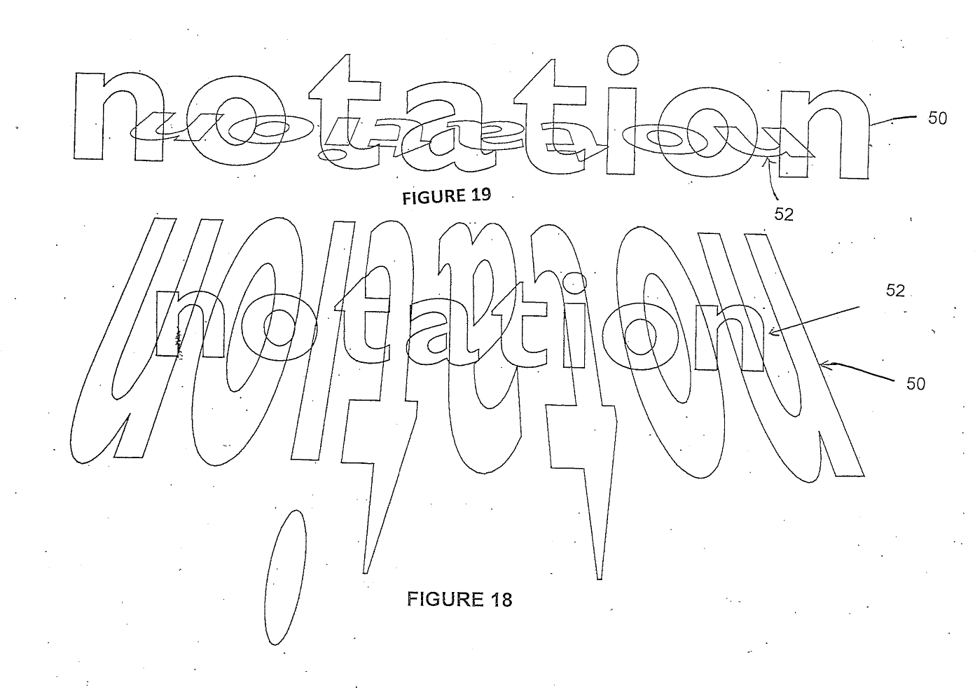

In FIG. 17 the images 50 and 52 and are superimposed on one another. When viewed by the near camera along the line of viewing V1, the primary image 52 appears to “stand up” (see FIG. 18) whereas the secondary image 50 forms a shadow effect which appears to lie in the ground plane underneath the primary image. When viewed by the far side camera along the line of viewing V2, the primary image 50 appears to “stand up” (see FIG. 19) whereas the secondary image 52 forms a shadow effect which appears to lie in the ground plane behind the primary image. As illustrated both images can be the same but they could be different to one another.

It is also possible to form the two IPT images by means of a multitude of LEDS carried by a mat. In its simplest form each IPT image is constituted by a plurality of LEDS which are laid out in an array dictated by the format of the IPT image to be displayed. The LEDS are laid out in much the same way as the painted images in FIG. 14. The LEDs of one mat representing the IPT image to be viewed by the near side camera are illuminated as are the LEDs of the other mat which is to be viewed by the same camera but at a greater distance. When the camera in use changes, the diode arrays that are illuminated are reversed so that the camera which has come into use “sees” the same image as the previously used camera.

As the LEDs can be computer controlled and illuminate instantaneously, the arrays of the single mat can be illuminated in a variety of different ways so that different images can be viewed.

If some of the multitude of LEDs are positioned so as to direct light in one direction and others are positioned to direct light in the opposite direction, then IPT images can be provided on each of the two mats for both pitch-end cameras simultaneously.

1. A visual advertisement which is carried by a substrate, the advertisement comprising a first inverse perspective transformation image and a contiguous second inverse perspective transformation image, the images being inverted with respect to one another and the first image, when the images are viewed in one direction, being the predominant image, and the second image being a subsidiary image and the second image being the predominant image when the images are viewed in the opposite direction and the first image being the subsidiary image.

2. A visual advertisement as claimed in claim 1, wherein the images are superimposed on one another.

3. A visual advertisement as claimed in claim 1, wherein the images are end-to-end in the direction of the line along which the images are viewed.

4. A mat comprising upstanding pile elements each of which has a first surface and an opposed second surface whereby said first surfaces are the only visible surfaces when the mat is viewed in one direction and the second surfaces are the only visible surfaces when the mat is viewed in the opposite direction, each of said first surfaces having part of a first image applied thereto, such parts together constituting the first image, and each of said second surfaces having part of a second image applied thereto, such parts together constituting the second image.

5. A method of producing images which comprises providing a mat having a backing and a pile upstanding from the backing and constituted by strands which have discrete opposed surfaces, manipulating the strands so that they lie over in one direction to expose one surface of each strand, applying a first image to said one surfaces of the strands, manipulating the strands so that they lie over in the opposite direction to expose the other surfaces of the strands, applying a second image to said other surfaces, and manipulating the strands back to their position normal to the backing.

6. A method of producing a mat which carries two images one of which is visible as an accurate image when the mat is viewed in one direction and the other of which is visible as an accurate image when the mat is viewed in the other direction, which method comprises printing images in alternating strips, and inverted with respect to one another, onto a sheet, securing an edge zone of the sheet to a backing layer, folding the sheet adjacent to said edge zone to provide a double thickness rib one external face of which carries part of one image and the other external face of which carries part of the other image, attaching the rib, on the opposite side to said zone, to the backing layer and repeating the attaching and folding sequence to provide a multitude of parallel ribs.

7. A method as claimed in claim 6 with the modification that the sheet is replaced by a plurality of ribbons.

8. A method of producing two images one of which is visible as the predominant image when viewed in one direction and the other of which is visible as the predominant image when viewed in the opposite direction, the method comprising applying inverted first and second images immediately adjacent one another along the viewing line.

9. A method as claimed in claim 8 with the modification that the images are superimposed on one another.

10. A method as claimed in claim 8 or 9, wherein one image is bigger than the other.

11. A method as claimed in any one of claims 5 to 10, wherein the images are inverse perspective transformation images.

12. In combination a mat comprising a plurality of light emitting diodes and a computer for controlling the diodes to illuminate those required to produce an image.

13. The combination of claim 12, wherein the diodes are controlled so as to be illuminated to produce two inverse perspective transformation images one of which predominates when viewed from one direction and the other of which predominates when viewed from the opposite direction.

14. The combination of claim 13, wherein the images are end-to-end in the direction of viewing.

15. The combination of claim 13, wherein the images are superimposed on one another.
